(19) United States
(12) Patent Application Publication
(10) Pub. No.: US 2026/0294168 A1
(43) Pub. Date: Oct. 1, 2026

(54) ELECTRIC PIZZA OVEN AND METHOD OF USE

(71) Applicant: OONI LIMITED, Broxburn (GB)

(72) Inventors: Iain MORTIMER, Edinburgh (GB); Callum WRIGHT, Edinburgh (GB); David KELLY, Roslin (GB)

(21) Appl. No.: 18/874,468

(22) PCT Filed: Jun. 7, 2023
(86) PCT No.: PCT/GB2023/051486

§ 371 Date: Dec. 12, 2024

(30) Foreign Application Priority Data
Jun. 14, 2022 (GB) 2208738.1

(51) Int. Cl. A47J 37/06; F24C 15/20; F24C 15/32

(52) U.S. Cl. CPC A47J 37/0658; A47J 37/0629; F24C 15/2007; F24C 15/32

(57) ABSTRACT

An electric pizza oven (1) comprising: a housing (2) retaining a cooking chamber (4), the housing and the cooking chamber together defining an opening (8) for access into the cooking chamber; an electric heat source (18A, 18B) configured to heat air in the cooking chamber to a temperature of at least 400 °C; an oven door (16) for closing the opening; and one or more outlets through which heated air and/or steam vents from the cooking chamber.

### FIELD OF THE INVENTION

The present invention relates to the field of electric pizza ovens and in particular electric pizza ovens with cooking chambers which are suitable for heating to temperatures 350 °C

### BACKGROUND TO THE INVENTION

Pizza ovens are commonly used for the cooking of baked goods and particularly pizzas. Such pizza ovens may be used to provide the very high cooking temperatures required to cook dough-based products adequately and to provide pizzas with a characteristically smoky or charred flavour. Before cooking any foodstuffs, the oven is preheated to the desired high temperature.

As the desired cooking temperature is increased, this results in an increase of the air temperature within the cooking chamber of the oven. As food stuffs typically contain some water, this also leads to steam being heated within the cooking chamber. This is particularly relevant to electric pizza ovens with cooking chambers which can be heated to temperatures in excess of 350 °C, because opening the door to the cooking chamber can lead to large volumes of hot steam rapidly leaving the cooking chamber.

It is within this context that the present disclosure has been devised.

### SUMMARY OF THE INVENTION

A first aspect of the invention provides an electric pizza oven comprising:
a housing retaining a cooking chamber, the housing and the cooking chamber; (e.g. together) defining an opening for access into the cooking chamber;
a heat source;
an oven door for closing the opening; and
one or more (optionally two or more) outlets through which (e.g. in use) heated air and/or steam can vent from the cooking chamber.

The cooking chamber may define an (e.g. the) opening for access into the cooking chamber. The housing may define an (e.g. the) opening for access into the cooking chamber, for example an opening aligned with the cooking chamber opening. The opening may be an opening configured for access to the cooking chamber. The oven door may be configured to close the opening. The oven door and housing may together define a first enclosed space (e.g. within which the cooking chamber is retained) and optionally the oven door and the cooking chamber may together define a second enclosed space (e.g. the space within the cooking chamber). The heat source may be in electric heat source. The heat source may comprise (e.g. be) one or more electric 21 heating elements. The heat source may be configured to heat air in the cooking chamber to a temperature of at least 400 °C

Air typically does not enter the cooking chamber via the or each outlet. The or each outlet may be (e.g. partially) throttled. The or each outlet may be (e.g. at least partially) resistant to airflow. It will be understood that an outlet that is (e.g. at least partially) resistant to airflow will still allow some flow of air. For example, the or each outlet may be configured such that the pressure in the cooking chamber increases above ambient pressure in use, e.g. whilst still allowing some heated air and/or steam to leave the cooking chamber via the outlet. The pressure in the cooking chamber may increase above ambient pressure. The pressure in the cooking chamber may increase to at least 1% above ambient pressure, or at least 2% above ambient pressure. The pressure in the cooking chamber may increase to (e.g. at least) 1.01 atm, or 1.02, atm, or 1.05 atm, or 1.1 atm, or 1.2 atm, optionally no more than 1.5 atm, or no more than 1.4 atm, or no more than 1.3 atm.

Although ovens which use combustible fuels (e.g. charcoal, woodchips, gas, etc.) require an air inlet to allow combustion, this is not the case for electric ovens. Instead, electric ovens typically use an electric means (e.g. an electric heating element) to heat the air in the cooking chamber without the need for an air inlet, as no combustion need take place. With such an electric heating mechanism, an air inlet would thus be inconvenient and inefficient, as it would allow cooler air to enter the cooking chamber, reducing the temperature therein. Accordingly, it may be that the cooking chamber does not comprise an air inlet, e.g. other than the opening (although the skilled person appreciate that the cooking chamber need not necessarily be, and typically is not, airtight).

The housing may comprise an air inlet, e.g. other than the opening, optionally an air inlet which is not in fluid communication with the cooking chamber. An air inlet may be useful for cooling the housing, for example so that the walls of the housing do not exceed a predetermined temperature.

Where cooking chambers of ovens are raised to higher temperatures, this can lead to increased pressure of the heated air, and in some cases steam and smoke, within the cooking chamber. The increased pressure within the cooking chamber can lead the heated air (and/or steam, smoke) to be forced into unintended spaces, and/or to exit the oven in an uncontrolled way, for example via small gaps in joints between parts of the housing, the cooking chamber, or the oven door. This can lead to damage of the oven and inconvenience to the user.

In particular, steam leaving the cooking chamber in an uncontrolled way tends to subsequently cool and then to condense on surfaces outside the cooking chamber. This can lead to water pooling around the oven and in spaces within the housing. Further, when the oven door is opened during cooking, the change in pressure causes a large amount of heated air (and/or steam, optionally humid air) to rapidly leave via the door.

These issues are mitigated by the provision of an oven with one or more outlets through which, in use, heated air (and/or steam, smoke, etc.) can vent from the cooking chamber. This is because the heated air and/or steam will leave the oven via the path of least resistance, which is via the outlets (at least when the door is closed) rather than via another route. This also prevents a large pressure build up, reducing the volumes of heated air (and/or steam, humid air, smoke) which leave via the oven door when the oven door is opened.

The cooking chamber and/or the housing may each comprise (e.g. be defined by) one or more walls. The housing (and optionally the cooking chamber) may comprise a top, base, left side, right side and rear (e.g. in addition to the opening). An internal space may be defined between the (e.g. walls of the) housing and the (e.g. walls of the) cooking chamber.

The one or more outlets may each be configured such that such that heated air and/or steam venting from the cooking chamber thereby enters the internal space, for example rather than (e.g. directly) exiting the oven. Alternatively or additionally, the one or more outlets may each be configured such that heated air and/or steam venting from the cooking chamber exits the electric pizza oven (optionally via the internal space).

The one or more outlets may be positioned such that heated air (and/or steam) exits the oven via the top of the housing. The opening of the housing is typically positioned at the front of the oven. Indeed, the front of the oven may be defined as the part of the oven at which access to the cooking chamber is available via the opening when the oven door is opened. In other words, the oven (and optionally the cooking chamber) may be understood to comprise a front portion (e.g. half) and a rear portion (e.g. half) with the front portion being closer to the opening and the door, and the rear portion being further from the opening and the door. The heat source is typically positioned in the rear portion of the oven (typically in the rear portion of the cooking chamber).

The outlets may define airflow paths. The airflow paths may extend from the interior of the cooking chamber to the exterior of the oven, optionally at or near a front portion of the oven, e.g. above and close to the oven door. Alternatively, the airflow paths may extend from the interior of the cooking chamber to the internal space. For example, the one or more outlets may each comprise a first aperture defined in a wall of the cooking chamber and a (e.g. corresponding) second aperture defined in the wall of the housing, such that an airflow path is provided from the interior of the cooking chamber to the exterior of the oven. The or each first aperture may be defined in an uppermost or top wall of the cooking chamber. The airflow paths may each be within a one or more ducts extending between one or more first apertures and one or more second apertures. However, in some embodiments, the outlets may each comprise an aperture in a wall of the cooking chamber. There may be the same number of apertures defined in the walls of the cooking chamber as there are apertures defined in the walls of the housing, however this is not required.

The or each outlet may be positioned such that heated air (and/or steam) leaves the oven (optionally the cooking chamber) close to and above the oven door. For example, the second aperture defined in the housing may be positioned in the top of the housing. The second aperture defined in the housing may be within 5 centimetres, optionally 2 centimetres, optionally 1 centimetre, of a point where the (e.g. top of the) housing meets the oven door when the oven door is closed.

Positioning outlets close to the oven door is advantageous, as this position is correspondingly further from the heat source. Accordingly, the air and steam which leaves via the outlets is cooler because it is further from the heat source.

Each second aperture (and optionally the or each first aperture) may have an area of at least 400 mm² , or at least 500 mm², or at least 600 mm² . Each second aperture (and optionally the or each first aperture) may have an area of no more than 1,200 mm² , or no more than 1,000 mm² , or no more than 800 mm ² . Alternatively, the combined area of the or each second aperture (and optionally the or each first aperture) may be at least 800 mm² , or at least 1,000 mm² , or at least 1200 mm² , e.g. where more than one second aperture (and optionally first aperture) is provided. The combined area of the or each second aperture (and/or the or each first aperture) may be no more than 2,000 mm² , or no more than 1,600 mm² , e.g. where more than one second aperture (and optionally first aperture) is provided.

For example, the or each aperture may be a rectangular hole having a width of at least 20 mm, or at least 40 mm, or at least 60 mm, optionally less than 100 mm, or less than 90 mm, or less than 80 mm; and a height of at least 5 mm, or at least 10 mm, or at least 20 mm, optionally less than 50 mm, or less than 40 mm, or less than 30 mm.

Apertures of the sizes described above are large enough that heated air and steam will preferentially leave via these apertures rather than via some other route (provided that the oven door is closed). In addition, apertures of the sizes described above are small enough that heated air and steam will leave relatively more slowly than would be the case with larger apertures, and so heated air is retained in the cooking chamber for longer.

The or each second aperture may be positioned such that heated air and/or steam leaving via the second aperture exits the oven, directly into atmosphere surrounding the oven, e.g. without first traveling through a duct extending from the housing. It will thus be understood that the outlets are not flues. Typically the oven does not comprise flue. A flue is a duct which extends a distance beyond (and typically above) an oven housing. Electric ovens typically do not have flues and typically do not have air inlets. For a flue to function an air inlet must also be provided so that air may be drawn into the cooking chamber to replace air leaving via the flue. In contrast, the electric pizza oven typically does not have an air inlet and the pressure causing heated air and steam to leave via the outlet is the result of heating the air and steam (although it should be noted that the cooking chamber would typically not be airtight, even if no outlets were provided, and the skilled person will thus understand that some air may naturally enter the cooking chamber in use, although the increased pressure in the cooking chamber makes this unlikely when the oven is in use).

The walls (e.g. the external walls) of the housing may comprise one or more insulated regions. For example, the housing may comprise an insulated region surrounding the or each second aperture. The or each insulated region may comprise a plastics material. The or each insulated region may comprise silicon rubber. The oven may comprise one or more moisture guides, configured to guide moisture (e.g. steam, water) leaving the outlets. For example, the or each moisture guides may be configured to encourage moisture (e.g. steam, water) to flow away from the front of the oven and/or away from the door. The or each moisture guide may be comprise an insulating material, for example a plastics material or silicon rubber.

The oven may be suitable for use at temperatures (e.g. up to and) above 350 °C, e.g. up to 450 °C, or up to 500 °C, or up to 550 °C. The heat source may be configured to heat air in the cooking chamber through temperatures from room temperature (e.g. 20 °C) up to a temperature at least 350 °C, or at least 400 °C, or at least 450 °C, or at least 500 °C. Where cooking chambers have temperatures above 350 °C, it is particularly helpful to have a controlled way for heated air and steam to leave the cooking chamber. The oven may comprise controller configured to regulate the temperature within the cooking chamber thermostatically, to thereby cause he temperature to be maintained at a setpoint. The setpoint may be at least 400 °C, or at least 450 °C, or at least 500 °C. In an example, the setpoint may be 400 °C±5 °C

The door may comprise a door handle. The oven door may comprise a window. The window may comprise at least two panes of glass with a space defined therebetween. For example, the window may comprise a first pane of glass and a second pane of glass with a first space defined therebetween, and optionally a third pane of glass with a second space defined between the second pane of glass and the third pane of glass. The provision of a window allows a user to observe foodstuffs in the cooking chamber as the foodstuffs cook. The provision of at least two panes of glass with spaces therebetween limits the temperature which the outermost pane of glass will reach during use of the oven. However, where the temperature of air in the cooking chamber exceeds 350 °C, heated air and/or steam can enter the spaces between the panes of glass. The steam then tends to condense on the cooler pane of glass, obstructing the view into the cooking chamber. The provision of outlets mitigates this issue, as the heated air and/or steam tends to leave via the outlets rather than seeping into the spaces between the panes of glass.

The oven may comprise legs extending from the base of the housing. The cooking chamber may retain a pizza, e.g. in use. The oven may comprise a user interface for controlling the oven, e.g. for controlling the temperature in the cooking chamber. The one or more foodstuffs may comprise (e.g. be) one or more pizzas. A further aspect of the invention provides a method of using an electric pizza oven, the electric pizza oven comprising: a housing retaining a cooking chamber, the housing and the cooking chamber (e.g. together) defining an opening for access into the cooking chamber; an electric heat source configured to heat air in the cooking chamber to a temperature of least 400 °C; an oven door for closing the opening; and one or more outlets,

the method comprising:
causing the electric heat source to heat the cooking chamber;
inserting one or more foodstuffs into the cooking chamber (e.g. via the oven door and the opening);
heated air and/or steam venting from the cooking chamber via the one or more outlets;
leaving the one or more foodstuffs in the cooking chamber for a cooking period; and
removing the one or more foodstuffs from the cooking chamber (e.g. via the oven door and the opening).

Leaving the one or more foodstuffs in the cooking chamber for a cooking period may comprise water evaporating from the one or more foodstuffs and forming steam. The method may comprise evaporating water from the one of more foodstuffs to thereby form steam. The method may comprise allowing the pressure within the cooking chamber to increase above ambient pressure. For example, the pressure in the cooking chamber may increase to at least 1% above ambient pressure, or to at least 2% above ambient pressure. The pressure in the cooking chamber may increase to (e.g. at least) 1.01 atm, or to 1.02 atm, or to 1.05 atm, or 1.1 atm, or 1.2 atm, optionally no more than 1.5 atm, or no more than 1.4 atm, or no more than 1.3 atm. The method may comprise allowing (optionally encouraging) a portion of the heated air and optionally steam in the cooking chamber to leave (e.g. vent from) the cooking chamber through one or more of the one or more outlets.

It will be understood that an electric pizza oven is a pizza oven that is powered by electricity. For example, it may be a pizza oven having one or more electric heating means (e.g. electric heating elements).

It will be understood that any features described above in relation to the apparatus may also be optional features of the other aspects of the invention. Steps in the method may be carried out in the order described herein, or in some cases in another order. In some cases one or more steps in the method may be carried out simultaneously.

### DESCRIPTION OF THE DRAWINGS

An example embodiment of the present invention will now be illustrated with reference to the following Figures in which:

FIG. 1 is a cross-sectional diagram of an electric pizza oven according to an example embodiment of the invention;

FIG. 2 is a cross-sectional detail view of a portion of the oven of FIG. 1;

FIG. 3 is a cross-sectional perspective view diagram of the oven of FIGS. 1 and 2;

FIG. 4 is a diagram of a cooking chamber of an electric pizza oven according to the example embodiment of FIGS. 1 to 3;

FIG. 5 is a perspective view diagram of a cooking chamber of an electric pizza oven according to the example embodiment of FIGS. 1 to 4; and

FIG. 6 is a flow chart of steps in a method according to an example embodiment of the invention.

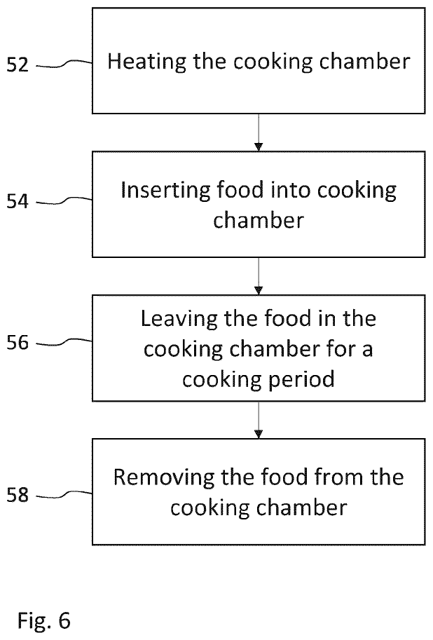

### DETAILED DESCRIPTION OF AN EXAMPLE EMBODIMENT

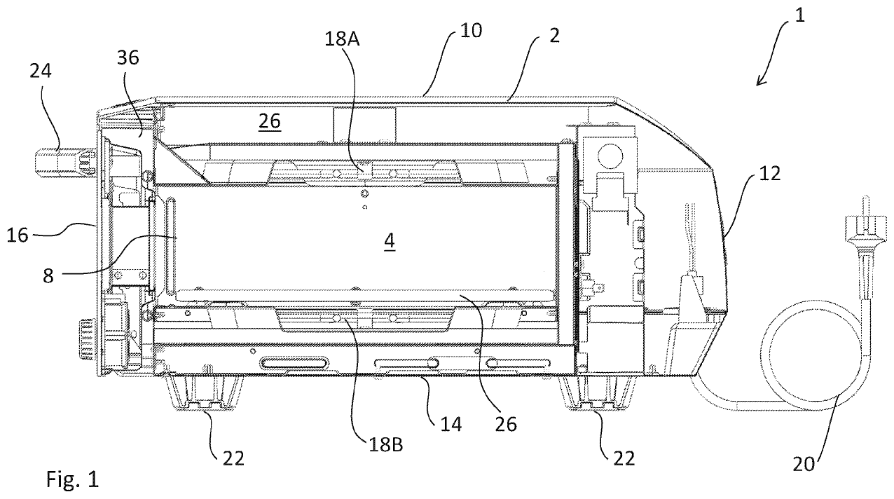

FIG. 1 is a cross-sectional diagram of an electric pizza oven 1 according to an example embodiment of the invention. The oven 1 has a housing 2 which retains a cooking chamber 4. The housing 2 defines an opening 8 at the front of the oven 1 to allow access into the cooking chamber 4. The housing 2 also has an upper wall 10, a rear wall 12 and a base wall 14, as well as left-and right-side walls (not shown). An oven door 16 is provided to close the opening 8 when access into the cooking chamber 4 is not required. An internal space 28 is defined between the cooking chamber 4 and the housing 2. Four feet 22 (two of which are not shown) extend from the base wall 14 of the housing 2. The door has a door handle 24.

The oven 1 also has an electric heat source in the form of first and second electric heating elements 18A, 18B, positioned at the top and base of the cooking chamber 4.

The electric heating elements 18A, 18B are suitable for heating air in the cooking chamber 4 through temperatures up to 450 °C. The electric heat source 18 is powered by mains power, via a power cable 20. Within the cooking chamber there is a cooking surface 26 in the form of a ceramic pizza stone which is positioned above the second electric heating element 18B.

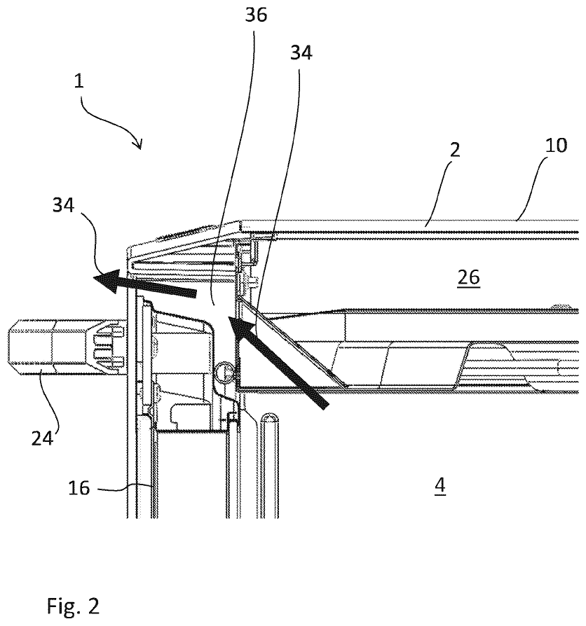

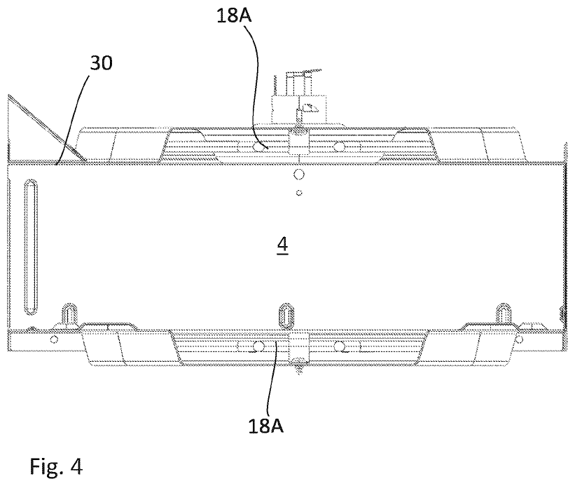

FIG. 2 is a detail view of a portion of the oven of FIG. 1. From this it can be seen that the oven 1 has an outlet in the form of a first pair of apertures 30A, 30B in the cooking chamber 4 (best seen in FIG. 4) and a second pair of apertures in the housing 2, the second apertures being provided above the door 16. Each aperture is defined as a 40 mm by 10 mm rectangular hole. In this example embodiment, each rectangular hole has rounded corners, however this is not required. This skilled person will appreciate that generally any shape of hole may be used without departing from the invention.

As a result of the apertures, there is an airflow path as indicated by arrows 34, leading from the interior of the cooking chamber 4 directly to the exterior of the oven 1, via a duct 36, the duct ending in the apertures in the housing, near to the top of the oven 1 and close to the door 16.

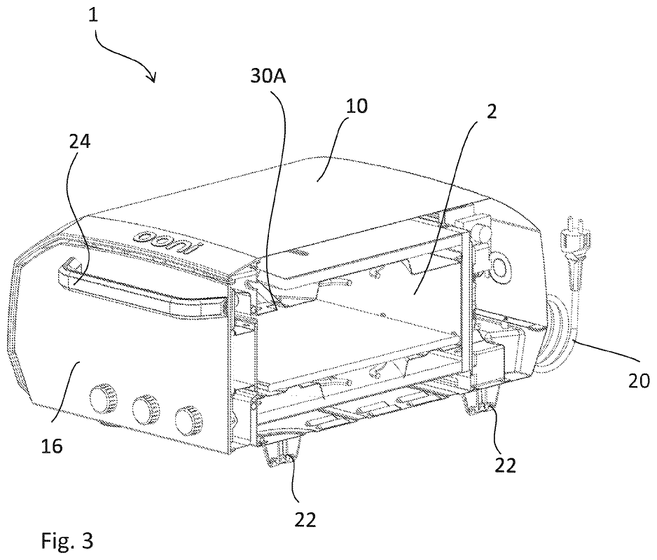

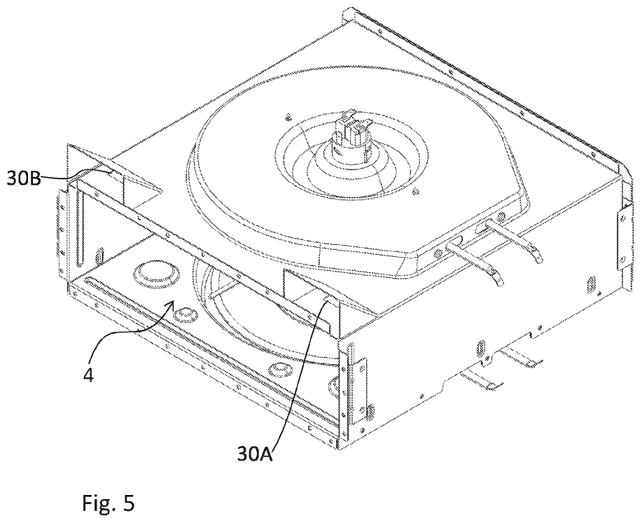

FIG. 3 is a cross-sectional perspective view diagram of the electric pizza oven according to the example embodiment of the invention. FIG. 4 is a cross-sectional diagram of a cooking chamber 4 of an electric pizza oven 1 according to the example embodiment of the invention, without the other parts of the pizza oven 1 being shown. FIG. 5 is a perspective view diagram of the same cooking chamber 4.

In use, the power is supplied to one or both of the electric heating elements 18A, 18B, causing the temperature of the air and the cooking surface 26 in the cooking chamber 4 to increase. When the temperature of the air and the cooking surface have reached the desired cooking temperature (e.g. 400 °C for cooking a pizza), the user opens the door 16 to insert a foodstuff (e.g. a pizza) and closes the door 16 to allow the foodstuff to cook.

The high temperatures lead to moisture in the foodstuff turning into steam within the cooking chamber 4. This steam is thus also heated by the heating elements 18A, 18B. As the cooking chamber 4 is enclosed (but not airtight) the pressure within the chamber 4 increases above ambient pressure. Due to the pressure differential, heated air and steam tends to leave the cooking chamber 4 (and subsequently the oven 1) via the apertures, following the airflow path 34. As the apertures provide a path of relatively lower resistance (provided that the door 16 is closed), heated air and steam leave via this route, rather than by other routes, and rather than being forced into other unintended spaces within the oven.

FIG. 5 is a flow chart of steps in a method according to an example embodiment of the invention. In this method, the steps include heating 52 the cooking chamber; inserting 54 food into the cooking chamber; leaving 56 the food in the cooking chamber for a cooking period; and removing 58 the cooked food from the cooking chamber. The method typically also includes allowing heated air and steam to vent from the cooking chamber 4 via the outlets.

Advantageously, the provision of an oven 1 having apertures to allow heated air and steam to exit the cooking chamber 4 means that the heated air and steam leave the oven 1 in a controlled way. This is particularly important for an electric pizza oven 1 with heating elements 18A, 18B configured to increase the temperature within the cooking chamber 4 to above 350 °C, as such ovens do not have air inlets or flues indeed, providing these would be inefficient, as it would mean allowing an intake of cool air, thus reducing the temperature within the cooking chamber 4). Without an air inlet or a flue, the temperature within the cooking chamber 4 increases, and heated air and steam tends to enter unintended spaces as a result, potentially leading to damage to the oven 1 and inconvenience to the user. This can also mean that an inconvenient high-volume flow of heated air and steam leaves via the oven door 16 if this is opened during cooking. Aspects of the invention as described herein mitigates some of these issues.

Although in the embodiments described the cooking chamber 4 and housing 2 each have two apertures, it will be understood that other numbers of apertures may be provided. Additionally, while it may be preferable for the airflow path 34 to be arranged such that heated air and steam leaves near the top of the oven and close to the door, this is not required and other airflow paths 34 may be used in the alternative. Further, the apertures may have different sizes and/or have different shapes to those described herein. While the airflow path 34 may be enclosed within a duct 36, this is not required and in some instances the pressure differential between the interior of the cooking chamber 4 and the atmospheric pressure surrounding the oven may be relied upon to define the airflow path 34.

Although in the embodiments described, the oven has first and second heating the elements 18A, 18B in the base and top of the cooking chamber, it will be understood that other numbers of heating elements may be provided, and optionally in other locations within the cooking chamber. Further, the heating elements 18A, 18B may be suitable for heating air in the cooking chamber 4 above 450 °C, e.g. up to 500 °C

It will be understood by those skilled in the art that any dimensions and relative orientations are within expected structural tolerances and limits for, the technical field and the apparatus described, and these should be interpreted with this in mind. For example, for the purpose of this application, the terms “upper” and “lower” are intended to refer to directions of the oven 1 in normal use. The term “upper” corresponds to vertically higher position than the term “lower”. Similarly, the terms “front” and “rear” are intended to refer to directions of the pizza oven in normal use.

In summary, there is provided an electric pizza oven (1) comprising: a housing (2) retaining a cooking chamber (4), the housing and the cooking chamber together defining an opening (8) for access into the cooking chamber; an electric heat source (18A, 18B) configured to heat air in the cooking chamber to a temperature of at least 400 °C; an oven door (16) for closing the opening; and one or more outlets through which heated air and/or steam vents from the cooking chamber.

1. An electric pizza oven comprising:
a housing retaining a cooking chamber, the housing and the cooking chamber defining an opening for access into the cooking chamber;
an electric heat source configured to heat air in the cooking chamber to a temperature of least 400 °C;
an oven door for closing the opening; and
one or more outlets through which heated air and/or steam can vent from the cooking chamber.

2. An electric pizza oven according to claim 1, wherein the or each outlet is positioned such that heated air and/or steam leaves the oven close to and above the oven door.

3. An electric pizza oven according to claim 1, wherein the cooking chamber and the housing are each defined by one or more walls, wherein an internal space is defined between the walls of the housing and the walls of the cooking chamber, and wherein the one or more outlets are each configured such that heated air and/or steam venting from the cooking chamber enters the internal space.

4. An electric pizza oven according to claim 1, wherein the cooking chamber and the housing are each defined by one or more walls, and wherein the one or more outlets each comprise a first aperture defined in a wall of the cooking chamber and a second aperture defined in a wall of the housing, such that an airflow path is provided from the interior of the cooking chamber to the exterior of the oven.

5. An electric pizza oven according to claim 4, wherein the or each second aperture has an area of at least 400 mm² .

6. An electric pizza oven according to claim 4, wherein the or each second aperture is positioned such that heated air and/or steam leaving via the second aperture leaves directly into the atmosphere surrounding the oven.

7. An electric pizza oven according to claim 4, wherein the walls of the housing may comprise one or more insulated regions, optionally wherein the walls of the housing comprise at least one insulated region surrounding the or each second aperture.

8. An electric pizza oven according to claim 1, wherein the or each outlet is resistant to airflow.

9. An electric pizza oven according to claim 1, wherein the oven comprises one or more moisture guides, configured to guide moisture leaving via the outlets, optionally wherein the or each moisture guides is configured to encourage moisture to flow away from the front of the oven and/or away from the door.

10. An electric pizza oven according to claim 1 wherein the oven is suitable for use at temperatures above 400 °C

11. An electric pizza oven according to claim 1, wherein the oven door comprises a window, the window comprising at least two panes of glass with a space defined therebetween.

12. An electric pizza oven according to claim 1, wherein the electric heat source comprises one or more electric heating elements.

13. A method of using an electric pizza oven, the electric pizza oven comprising:
a housing retaining a cooking chamber, the housing and the cooking chamber defining an opening for access into the cooking chamber;
an electric heat source configured to heat air in the cooking chamber to a temperature of least 400 °C;
an oven door for closing the opening; and
one or more outlets,
the method comprising:
causing the electric heat source to heat the cooking chamber;
inserting one or more foodstuffs into the cooking chamber;
heated air and/or steam venting from the cooking chamber via the one or more outlets;
leaving the one or more foodstuffs in the cooking chamber for a cooking period;
and
removing the one or more foodstuffs from the cooking chamber.

14. A method according to claim 13, wherein leaving the one or more foodstuffs in the cooking chamber for a cooking period comprises water evaporating from the one or more foodstuffs and forming steam.

15. A method according to claim 13 comprising allowing the pressure within the cooking chamber to increase above ambient pressure.

16. A method according to claim 13, comprising allowing a portion heated air, and optionally steam, in the cooking chamber to leave the cooking chamber through one or more of the or each outlet.

17. A method according to claim 13, wherein the one or more foodstuffs comprises one or more pizzas.
